(19) United States
(12) Patent Application Publication
(10) Pub. No.: US 2026/0269091 A1
(43) Pub. Date: Sep. 10, 2026

(54) HEAT PIPE MEASUREMENT SYSTEMS AND METHODS

(71) Applicant: Westinghouse Electric Company LLC, Cranberry Township, PA (US)

(72) Inventors: Gregory Edward Joseph Kinzler, Pittsburgh, PA (US); Jeffrey L. Arndt, Pittsburgh, PA (US)

(73) Assignee: Westinghouse Electric Company LLC, Cranberry Township, PA (US)

(21) Appl. No.: 19/071,246

(22) Filed: Mar. 5, 2025

(51) Int. Cl. G21C 7/32; G01F 1/60; G01F 1/86; G21C 15/257

(52) U.S. Cl. CPC G21C 7/32; G01F 1/60; G01F 1/86; G21C 15/257

(57) ABSTRACT

Systems and methods for related to heat pipe flow measurement are disclosed. In some embodiments, a heat pipe flow measurement may be used in a method for controlling a nuclear reactor. The method may include measuring a first operating parameter associated with a flow of a working fluid within a heat pipe of the nuclear reactor and determining, based on the first operating parameter, a second operating parameter associated with an amount of thermal energy transferred by the heat pipe.

### BACKGROUND

A heat pipe may be described as sealed passive device capable of transferring thermal energy via the flow of a working fluid. The working fluid flows back and forth along the heat pipe, cycling between a hot primary section and a cold secondary section. Generally, the working fluid in the hot primary section evaporates as it absorbs thermal energy, flows as a vapor towards the cold secondary section, condenses in the cold secondary section as it releases thermal energy, and returns to the hot primary section as a liquid. A wick section spanning a length of heat pipe may define flow paths the liquid phase of the working fluid.

Nuclear reactors may utilize heat pipe assemblies comprising multiple heat pipes for transferring thermal energy from the reactor core to a heat exchanger outside of the reactor core. Monitoring the power (e.g., rate of thermal energy transfer) of specific heat pipes within the heat pipe assembly can present various challenges. For example, conventional methods for monitoring reactor heat pipe operation typically involve inferring local power of a particular heat pipe based on global reactor power measurements. However, the inferred heat pipe characteristics may be locally inaccurate and may therefore present challenges related to controlling reactor operation based on a localized heat pipe power. Furthermore, placing a device within a heat pipe to directly measure local power may disrupt the flow characteristics of the working fluid and may therefore impact thermal energy transfer efficiency. Therefore, it may be desirable to develop alternative systems and methods for assessing heat pipe characteristics.

### SUMMARY

The following summary is provided to facilitate an understanding of some of the innovative features unique to the aspects disclosed herein and is not intended to be a full description. A full appreciation of the various aspects disclosed herein can be gained by taking the entire specification, claims, and abstract as a whole.

According to various aspects, the present disclosure provides a method for operating a nuclear reactor. The method may include measuring a first operating parameter associated with a flow of a working fluid within a heat pipe of the nuclear reactor and determining, based on the first operating parameter, a second operating parameter associated with an amount of thermal energy transferred by the heat pipe.

According to one aspect of the method, the first operating parameter is associated with a flow of the working fluid within an adiabatic section of the heat pipe.

According to one aspect of the method, the working fluid comprises an alkali metal. For example, the working fluid may comprise sodium.

According to one aspect of the method, the first operating parameter is associated with a mass flow rate of the working fluid within the adiabatic section of the heat pipe.

According to one aspect of the method, the mass flow rate of the working fluid is based on flow of a first phase of the working fluid and flow of a second phase of the working fluid.

According to one aspect of the method, the mass flow rate is based on a first portion of the working fluid flowing in a first direction and a second portion of the working fluid flowing in a second direction different from the first direction.

According to one aspect of the method, the first operating parameter corresponds to an electrical signal produced in response to energizing a portion of the flow of the working fluid within the adiabatic section of the heat pipe.

According to one aspect of the method, the first operating parameter is measured with an eddy current flow sensor.

According to one aspect of the method, the second operating parameter is a power of the heat pipe.

According to one aspect of the method, the first operating parameter is associated with a flow rate of the working fluid through the heat pipe, a the method further comprises correlating the flow rate of the working fluid to the amount of thermal energy transferred by the heat pipe.

According to one aspect, the method may include controlling an operation of the nuclear reactor based on at least one of the first operating parameter or the second operating parameter. For example, the method may include maintaining a power level of the nuclear reactor based on detecting a change in the second operating parameter for the heat pipe. The method may include controlling the operation of the nuclear reactor in real time with detecting the change in the second operating parameter of the heat pipe.

According to various aspects, the present disclosure provides a method for transferring heat with a heat pipe system. The method may include determining a rate of thermal energy transfer within a heat pipe based on a measured parameter indicative of fluid flow within a portion of the heat pipe. Th method may include exchanging a portion of the thermal energy as heat between a transfer section of the heat pipe and an environment surrounding the transfer section. The method may include determining the exchanged portion of the thermal energy based on the rate of thermal energy transfer.

According to one aspect of the method, the portion of the heat pipe may be within a condenser section of the heat pipe, an adiabatic section of the heat pipe, or an evaporator section of the heat pipe, or a combination thereof.

According to one aspect, the method may include measuring the measured parameter indicative of fluid flow within the portion of the heat pipe using an eddy current flow sensor.

According to one aspect, the method may include measuring the measured parameter indicative of fluid flow within the portion of the heat pipe with contactless sensor.

According to various aspects, the present disclosure provides a measurement system. The measurement system may include an eddy current sensor configured to be positioned around a portion of a heat pipe a control circuit configured to energize the eddy current sensor at a measurement frequency to determine a flow rate of a working fluid within the portion the heat pipe.

According to one aspect of the system, the working fluid comprises an alkali metal and has an operating temperature in a range of 600° C. to 900°.

According to one aspect of the system, the portion of the heat pipe is within a condenser section of the heat pipe, an adiabatic section of the heat pipe, or an evaporator section of the heat pipe, or a combination thereof.

According to one aspect of the system, the control circuit is configured to calculate a power of the heat pipe based on determining the flow rate of the working fluid within the portion of the heat pipe.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 illustrates a cross-sectional schematic view of a heat pipe, according to at least one non-limiting aspect of the present disclosure.

FIG. 2 illustrates a perspective view of a reactor core, according to at least one non-limiting aspect of the present disclosure.

FIG. 3 is a schematic representation of a measurement system, according to at least one non-limiting aspect of the present disclosure.

FIG. 4 illustrates a method for operating nuclear reactor, according to at least one non-limiting aspect of the present disclosure.

FIG. 5 illustrates a method for operating a heat pipe, according to at least one non-limiting aspect of the present disclosure.

FIG. 6 is a graph illustrating example outputs from the measurement system of FIG. 3, according to at least one non-limiting aspect of the present disclosure.

FIG. 7 is a graph illustrating example outputs from the measurement system of FIG. 3, according to at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

A heat pipe is a sealed passive device capable of transferring thermal energy via the flow of a working fluid. The flow of the working fluid may transfer heat from a hot primary side (e.g., evaporator section) to a cold secondary side (e.g., condenser section) of the heat pipe. Generally, the working fluid in the hot primary section evaporates as it absorbs thermal energy, flows as a vapor towards the cold secondary section, condenses in the cold secondary second as it releases thermal energy, and returns to the hot primary section as a liquid. A wick section spanning a length of heat pipe may define flow paths for the working fluid in the liquid phase and as it transitions between phase states.

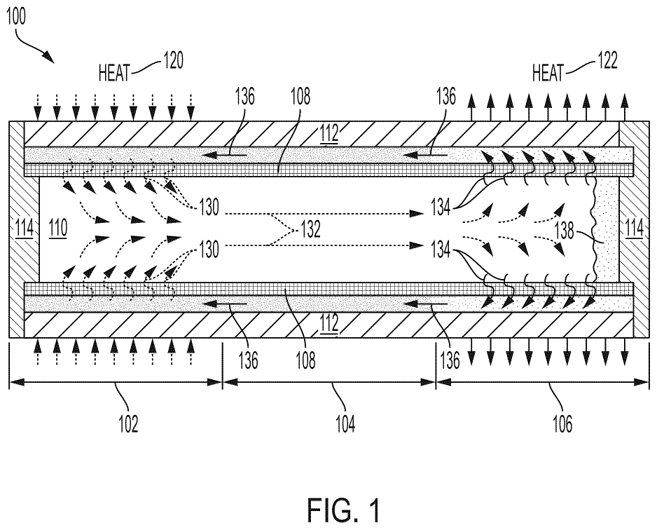

FIG. 1 illustrates an example heat pipe 100. The heat pipe 100 comprises a wick 108, an outer wall 112, end caps 114, an evaporator section 102, an adiabatic section 104, and a condenser section 106. The wick 108 may comprise pores, capillaries, grooves, and/or microchannels. The wick 108 defines a cavity 110 within the heat pipe 100. The cavity 110 may function as a central flow path within the heat pipe for vapor flow from the evaporator section 102 to the condenser section 106. The wick 108 can function as a flow path for liquid flow from the condenser section 106 to the evaporator section 102. The liquid flow may be driven by capillary action caused by the structure of the wick 108.

The heat pipe 100 may include a working fluid, such as, for example, water, potassium, sodium, or another alkali metal. In operation, the working fluid may exist in a liquid phase in the evaporator section 102 of the wick 108. The working fluid may absorb heat 120 (e.g., the working fluid's laten heat of vaporization) in the evaporator section 102, undergo a phase transition into a saturated vapor, and flow 130 into the cavity 110. As a vapor, the working fluid flows 132 through the adiabatic section 104 toward the condenser section 106 via the cavity 110. The working fluid may release heat 122 (e.g., the working fluid's latent heat of vaporization) in the condenser section 106, undergo a phase transition into a liquid, and flow 134 into the wick 108. Working fluid in the liquid phase may also collect in a liquid pool 138 at an end of the heat pipe 100. As a liquid, the working fluid flows 136 through the adiabatic section 104 toward the evaporator section 102 via the wick 108 and/or, in some embodiments, along a gap defined between the wick 108 and the outer wall 112. This phase change process and multi-phase flow circulation may continue as long as a temperature gradient between the evaporator section 102 and condenser sections 106 is maintained. Due to generally high heat transfer coefficients for evaporation and condensation, heat pipes are generally highly effective thermal conductors.

The heat pipe 100 may be employed to transfer thermal energy between a rector core and a heat exchanger of a nuclear reactor. For example, the heat pipe 100 may be positioned within a nuclear reactor such that the evaporator section 102 is located within the reactor core and the condenser section 106 is thermally coupled with the heat exchanger. Heat 120 from the reactor core may be transferred through the outer wall 112 of the heat pipe, thereby causing the working fluid to evaporate in the evaporator section 102, flow 136 to the condenser section 106, and release heat 122 to the heat exchanger resulting from condensation of the working fluid.

Nuclear reactors, such as, for example, microreactors or other nuclear reactors that generate less than 10 MWe, may include a plurality of heat pipes 100 to transfer thermal energy from the reactor core to a heat exchanger system.

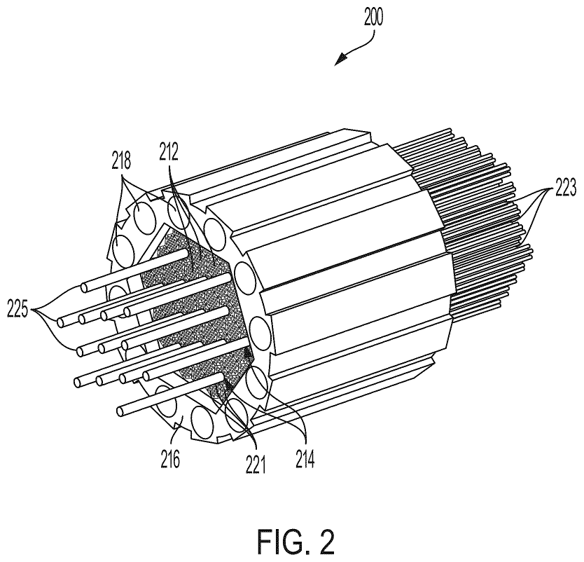

FIG. 2 illustrates a perspective view of a core section 200 of an example nuclear microreactor. The core section 200 may include fuel elements 221 (e.g., rods and/or stacks), control drums 218, heat pipes 223, and control rods 225. Each of the heat pipes 223 may be similar to the heat pipe 100 (FIG. 1). The fuel elements 221 may be positioned in fuel channels of the unit cells 212, and the heat pipes 223 may be positioned in heat pipe channels of the unit cells 212. The control rods 225 may be movably positioned in reactivity control channels of reactivity control cells 214. Positions of the control drums 218 and/or the control rods 225 can be adjusted to control reactivity. In some embodiments, adjustment of the control drums 218 may serve as a primary means of controlling reactivity during microreactor operation and adjustment of the control rods 225 may serve as a secondary means of controlling reactivity. For example, the control rods 225 may typically remain outside of the core section 200 during operation but may serve as safety rods that are inserted into the reactor core 200 (e.g., during shipment, during an accident condition). In some embodiments, the respective evaporator section of each heat pipe 223 may extend the length of the reactor core 210. The fuel elements 221 and/or the heat pipes 223 may extend an additional length beyond the length of the reactor core 210, for example, to facilitate downstream ex-core connections and/or equipment (e.g., power conversion systems, condensers, structural supports). Other examples of heat pipes in nuclear applications, which may be utilized in any of the system and methods described herein, are described in U.S. Pat. Nos. 5,684,848, and 6,768,781, U.S. Patent Application Publication No. 2016/0027536, and U.S. Patent Application Publication No. 2022/0139582, each of which are incorporated by reference in their entirety.

The heat pipes used in micro-reactors may experience extreme operating temperatures. Heat pipes used in microreactors may utilize a working fluid comprising an alkali metal, such as, for example, sodium. Any of the heat pipes disclosed herein may include a wick made of a material that is capable of withstanding extreme temperatures and/or that is compatible with alkali metal. Any of the heat pipes pipe disclose herein may comprises an alkali metal working fluid having an operating temperature greater than 600° C., an operating temperature greater than 800° C., an operating temperature in a range of 600° C. to 900° C., and/or an operating temperature in a range of 800° C. to 900° C., for example.

It may be desirable to monitor operational conditions of heat pipes during reactor operation. For example, a monitored power (e.g., thermal energy transfer rate) of the heat pipes may be used to control the reactor (e.g., adjust a reactivity of the reactor). Moreover, it may be desirable to not only monitor operational conditions of heat pipes in aggregate but to also monitor local operational conditions of individual heat pipes. For example, a monitored power of an individual heat pipe may be used to identify a local condition within the reactor and implement a localized control adjustment (e.g., adjust a position of a control rod or rods) based on the local condition. As another example, a monitored power of an individual heat pipe may be used to identify that the heat pipe needs to be serviced (e.g., replaced or repaired).

The inventors have determined that heat pipe power may be correlated with a flow rate (e.g., mass flow rate) of the working fluid within the heat pipe. Thus, a flow rate of the working fluid within the heat pipe may be measured and the power of a heat pipe may be derived from the flow rate. Conventional methods for measuring a flow rate within a pipe often rely on placing an internal flow sensor within the flow path of the fluid. However, adding an additional structure, such as an internal flow senser, within a heat pipe may disrupt the complex flow dynamics of the working fluid needed for efficient thermal energy transfer. Existing flow sensors are therefore generally not capable of monitoring heat pipe power conditions without disturbing the delicate flow dynamics.

Moreover, heat pipe power and flow dynamics are a difficult phenomenon to measure due to the complex muti-physics and multi-directional flow occurring within the heat pipe. Some approaches to monitoring heat pipe power involve performing a calorimetric heat balance on the evaporator and condenser sections of the heat pipe. While the calorimetric balance approach may work well for known single heat pipes, global thermodynamic characteristics such as calorimetric balances generally cannot provide insight into the thermodynamics and flow conditions within a particular heat pipe. Additionally, when heat pipes are assembled in a core block configuration within a nuclear reactor, defining the power of a single heat pipe becomes difficult through a system's level calorimetric balance due to the multi-physics effects of the system. Without knowledge of individual heat pipe power, local phenomenon in the reactor system must be inferred rather than directly measured, making operation of the reactor challenging. Therefore, there is a need for systems and methods for monitoring a power level of individual heat pipes.

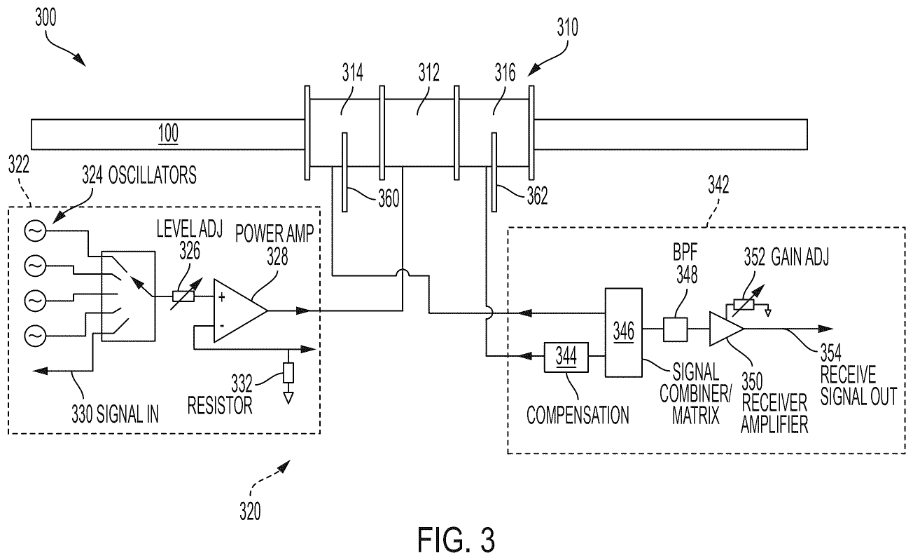

FIG. 3 is a schematic representation of a measurement system 300 capable determining a power (e.g., a rate of thermal energy transfer) of a heat pipe 100. The system 300 includes an eddy current flow sensor 310 and a control circuit 320. In some embodiments, the eddy current flow sensor 310 may be positioned around a portion of the adiabatic section 104 of the heat pipe 100 (FIG. 1). In some embodiments, the eddy current flow sensor 310 may be positioned around a portion the evaporator section 102 of the heat pipe 100, around a portion of condenser section 106 of the heat pipe, or around a portion of the heat pipe that across multiple different sections of the heat pipe 100 (e.g., across portions of the evaporator section 102 and the adiabatic section 104, across portions of the adiabatic section 104 and the condenser section 106). The eddy current flow sensor 310 and the control circuit 320 may measure a first parameter associated with a flow of the working fluid within the heat pipe 100, and the control circuit 320 may determine, based on the first operating parameter, a second operating parameter associated with a rate of thermal energy transfer of the heat pipe 100.

For example, the control circuit 320 may receive a signal (e.g., signals) generated by the eddy current flow sensor 310 that is associated with a mass flow rate of the working fluid through the heat pipe. The control circuit 320 may determine a rate of thermal energy transfer of the heat pipe 100 based on the signal that is associated with the mass flow rate. For example, the control circuit 320 may derive the thermal energy transfer of the heat pipe 100 based on correlations of the eddy current flow sensor 310 output and thermal energy transfer derived from analytical data and/or based on theoretical correlations of enthalpy change across the heat pipe, a measured temperature differential across the heat pipe 100, and the thermal energy transfer of the heat pipe 100. Referring to FIGS. 1 and 3, the working fluid in a vapor phase may flow 132 within the heat pipe 100 in a first direction and in a liquid phase may flow 136 within the heat pipe 100 in a second direction that is opposite from the first direction.

In some embodiments, the control circuit 320 and the eddy current flow sensor 310 can measure an overall mass flow rate of the working fluid within the adiabatic section 104 of the heat pipe 100 (e.g., a mass flow rate based on the combined flow 132 of the vapor phase and the flow 136 of the liquid phase). In some embodiments, the control circuit 320 and the eddy current flow sensor 310 can measure the flow 132 of the vapor phase (e.g., without measuring the flow 136 of the liquid phase). In some embodiments, the control circuit 320 and the eddy current flow sensor 310 can measure the flow 136 of the liquid phase (e.g., without measuring the flow 132 of the vapor phase).

Referring primarily to FIG. 3, the eddy current flow sensor 320 includes a drive coil 312, a first receive coil 314, and a second receive coil 316. The control circuit 320 may include a drive coil control portion 322 and a receive coil control portion 324. The drive coil control portion 322 may transmit a current with oscillating voltage (e.g., AC) to energize the drive coil 312 and cause the drive coil 312 to produce a magnetic field. The magnetic field may encompass the first receive coil 314 and the second receive coil 316 as well as a portion of the heat pipe 100.

The first receive coil 314 and the second receive coil 316 may be identical (e.g., comprising the same number of coils) and may be positioned symmetrically on each side of the drive coil 312. Each of the first receive coil 314 and the second receive coil 316 may be electrically coupled to the receive coil control portion 342 of the control circuit 320. The magnetic field produced by the drive coil 312 may induce a current in each of the first receive coil 314 and the second receive coil 316. The receive coil control portion 342 of the control circuit 320 may determine a voltage differential of the current induced in the first receive coil 314 and the second receive coil 316 based on signals received from the first receive coil 314 and the second receive coil 316.

If the working fluid is not flowing through the heat pipe 100, then the magnetic field produced by the drive coil 312 at each of the first receive coil 314 and the second receive coil 316 is expected to have a strength that is identical or substantially identical. Thus, the voltage differential of the current induced in the first receive coil 314 and the second receive coil 316 is expected be identical or substantially identical if the working fluid is not flowing through the heat pipe 100.

If the working fluid is flowing through the heat pipe 100, then the magnetic field produced by the drive coil 312 can cause eddy currents to develop in the flowing fluid. The eddy currents modify the strength of magnetic field differently at the first receive coil 314 and the second receive coil 316 in a manner that may be correlated with the flow rate the working fluid flow. This difference in magnetic field strength results in a voltage differential between the current induced in the first receive coil 314 and the second receive coil 316. Thus, the measured voltage differential may be correlated with and used to determine the flow rate of the working fluid.

Still referring primarily to FIG. 3, the drive coil control portion 322 of the control circuit 320 may include a signal in 330 line, oscillators 324, a variable resistor 326, an operational amplifier 328, and a current sense resistor 322. The signal in 330 transmits a signal (e.g., from a processor, microcontroller, or another component of the control circuit 320) for controlling energization (e.g., current, frequency) of the drive coil 312. The oscillators 324 may deliver AC current at a selected frequency. The oscillators 324 may be configured to generate a frequency from a range of frequencies, such as, for example frequencies ranging from 60 Hz to 2000 Hz. The variable resistor 326 and the operational amplifier 328 may be included to modulate the current and voltage output to the drive coil 312.

The frequency of AC current used to energize the drive coil 312 may modify the resulting magnetic field and therefore may be adjusted to measure different aspects of the working fluid flow within the heat pipe 100. For example, a first frequency may be selected to target measurement of the flow 132 of the vapor phase of the working fluid. A second frequency may be selected to target measurement of the flow 136 of the liquid phase of the working fluid. A third frequency may be selected to target measurement of the combined flow 132 of the vapor phase and flow 136 of the liquid phase of the working fluid. The different first, second, and/or third frequencies may be selected based on the composition of the working fluid. In some embodiments, (e.g., where sodium is the working fluid) a frequency of about 400 Hz may be selected to target measurement of the combined flow 132 of the vapor phase and flow 136 of the liquid phase of the working fluid. In some embodiments, a frequency of 600 Hz to 2000 Hz may be selected to target measurement of the flow 136 of the liquid phase of the working fluid. In some embodiments, a frequency of 60 Hz to 600 Hz may be selected to target measurement of the flow 132 of the vapor phase of the working fluid.

Still referring primarily to FIG. 3, the receive coil control portion 342 of the control circuit 320 may include a compensation circuit 344, a signal combiner 346, a band pass filter 348, an amplifier 350, a variable resistor 352, and a signal out 354 line. The signal combiner 346 can receive input signals from each of the first receive coil 314 and the second receive coil 316 and output a signal indicative of the voltage different of the input signals. The band pass filter 348 may be included to filter signals outside of a specified frequency range. The amplifier 350 may amplify the output signal and may be adjustable based on the variable resistor 352. The signal out 354 line may transmit the output signal for further processing (e.g., to a processor, microcontroller, or another component of the control circuit 320). The output signal may be used to determine voltage difference based on a peak-to-peak voltage of the AC current waveform and/or a root mean square voltage of the AC current waveform.

The system may include a first thermocouple 360 to measure a temperature of the first receive coil 314 and a second thermocouple 362 to measure a temperature of the second receive coil 316. Differences in temperature between the first receive coil 314 and the second receive coil 316 can result in the first receive coil 314 and the second receive coil 316 having different levels of inductance. Thus, differences in temperature between the first receive coil 314 and the second receive coil 316 can result in a voltage differential that is not cause by flow of the working fluid, thereby introduce an additional (e.g., unwanted) variable in the flow measurement. The first thermocouple 360 and the second thermocouple 362 may monitor the temperatures of the coils to ensure that they are the same or substantially the same. Positioning the eddy current flow sensor 310 at the adiabatic section 104 of the heat pipe can help to ensure a constant temperature across the first receive coil 314 and the second receive coil 316.

The output signal indicative of the voltage differential at first receive coil 314 and the second receive coil 316 may be correlated with a flow rate of the working fluid within the heat pipe 100. Accordingly, the system 300 is capable of measuring operating parameters indicative of flow within the heat pipe 100. Components of the system 300 are not positioned within the heat pipe 100 and therefore minimize interference with the flow dynamics and thermal transfer efficiency of the heat pipe 100. Thus, the system 300 provides an alternative to approaches of flow measurement that involve placing a structure (e.g., sensor) within the flow path. Yet further, the system 300 is capable measuring operating parameters indicative of vaporized metal flow at temperatures above 600° C. Conventional sensors, such as ultrasonic flow sensors, are generally not suitable for such measurements, especially when considering the complex multi-phase and multi-directional flow dynamics of heat pipes.

As explained further in the related to the examples below, the inventors have determined parameters indicative of flow of the working fluid within a heat pipe may be correlated with the thermal energy transfer rate (e.g., power of the heat pipe). Thus, the system 300 may determine a thermal energy transfer rate of the heat pipe 100 based on measurements taken using the eddy current flow sensor 310.

In some embodiments, the control circuit 320 may include a processor and a memory. The memory may store instructions executable by the processor to determine a thermal energy transfer rate of the heat pipe 100 based on receiving an output signal indicative of the voltage differential from the signal out 354 line. The determination of the thermal energy transfer rate based on the output signal may be performed using a correlation determined analytically from experimental data and/or may be determined theoretically based on the relationship of the working fluid mass flow rate, the measured temperature, and the thermal energy transfer rate.

The system 300 may be used in combination with a nuclear reactor. For example, the system 300 may be arranged to accommodate an array of heat pipes, similar to the heat pipes 223 (FIG. 2), with an eddy current flow sensor 310 on several or all of the heat pipes. The system 300 may determine a thermal energy transfer rate (e.g., power) for each of the corresponding heat pipes associated with an eddy current flow sensor 310.

The reactor may be controlled based on the determined thermal energy transfer rates. For example, localized adjustments to reactivity (e.g., via adjustments of one or more of the control drums 218, via adjustments of one or more of the reactivity control rods 225) may be made based on analyzing thermal energy transfer rates of particular heat pipes. A specific heat pipe may be determined to have thermal energy transfer rate that is lower than a predetermined threshold value and the localized reactivity corresponding to that heat pipe may be increased. A specific heat pipe may be determined to have thermal energy transfer rate that is greater than a predetermined threshold value and the localized reactivity corresponding to that heat pipe may be decreased. As another example, the determined thermal energy transfer rates may be used to identify specific heat pipes that need to be serviced or replaced. A specific heat pipe may be determined to be damage, malfunctioning, and/or in need of replacement based on the heat pipe exhibiting thermal energy transfer rate that is lower than a predetermined threshold value.

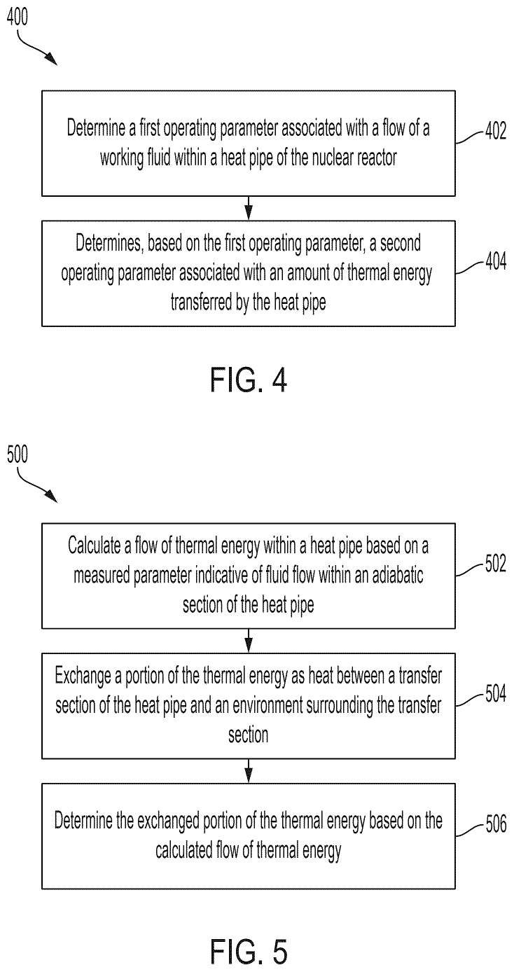

FIG. 4 illustrates a method 400 for operating a nuclear reactor. The method 400 may be carried out using any of the measurement systems, heat pipes, and/or reactors disclosed herein. For example, the method 400 may be carried out using the system 300.

According to the method 400, a control circuit determines 402 a first operating parameter associated with a flow of a working fluid within a heat pipe 100 of the nuclear reactor. Further, the control circuit determines 404, based on the first operating parameter, a second operating parameter associated with an amount of thermal energy transferred by the heat pipe 100. In some embodiments, the control circuit 320 of the system may determine 402 the first operating parameter and may determine 404 the second operating parameter.

In some embodiments of the method 400, the first operating parameter is associated with a flow of the working fluid within an adiabatic section 104 of the heat pipe 100.

In some embodiments of the method 400, the working fluid comprises an alkali metal. In some embodiments of the method 400, the working fluid comprises sodium.

In some embodiments of the method 400, the first operating parameter is associated with a mass flow rate of the working fluid within the adiabatic section 104 of the heat pipe 100. For example, the mass flow rate may be based on the mass flow of a first phase (e.g., liquid) of the working fluid and a second phase (e.g., vapor) of the working fluid. As another example, the the mass flow rate may be based on a first portion of the working fluid flowing 132 in a first direction and a second portion of the working fluid flowing 136 in a second direction different from the first direction.

In some embodiments of the method 400, the first operating parameter corresponds to an electrical signal produced in response to energizing a portion of the flow of the working fluid within the adiabatic section 104 of the heat pipe 100. For example, the first operating parameter may be measured with the eddy current flow sensor 310. The electrical signal may be indicative of a voltage differential across the first receive coil 314 and the second receive coil 316.

In some embodiments of the method 400, the second operating parameter is associated with a rate of heat 122 transfer to a heat exchanger of the reactor of by the heat pipe 100.

In some embodiments of the method 400, the second operating parameter is a power of the heat pipe.

In some embodiments of the method 400, the method 400 further comprises the method further correlating the flow rate of the working fluid to the amount of thermal energy transferred by the heat pipe. In some embodiments of the method 400, the method 400 further comprises determining a relationship between the first operating parameter and a heating load on the heat pipe, and determining the power of the heat pipe based on the relationship.

In some embodiments of the method 400, the method 400 further comprises controlling an operation of the nuclear reactor based on at least one of the first operating parameter or the second operating parameter. For example, the method 400 may include maintaining a power level of the nuclear reactor based on detecting a change in the second operating parameter for the heat pipe 100. Maintaining the power level may include adjusting a reactivity control rod of the nuclear reactor. Controlling the operation of the nuclear reactor may be performed in real time with detecting the change in the second operating parameter of the heat pipe.

FIG. 5 illustrates a method 500 for transferring heat with a heat pipe system. The method 500 may be carried out using any of the systems and heat pipes disclosed herein. For example, the method 500 may be carried out using the system 300.

According to the method 500, a flow of thermal energy within a heat pipe 100 is calculated 502 based on a measured parameter indicative of fluid flow within an adiabatic section 104 of the heat pipe 100. A portion of the thermal energy is exchanged 504 as heat between a transfer section (e.g., a condenser section 106) of the heat pipe and an environment surrounding the transfer section. The exchanged portion of the thermal energy is determined 506 based on the calculated flow of thermal energy.

According to some embodiments of the method 500, the measured parameter is measured with an eddy current flow sensor. According to some embodiments, the measured parameter is a voltage differential between receive coils of the eddy current flow sensor.

According to some embodiments of the method 500, the measured parameter is indicative of liquid phase fluid flow. According to some embodiments of the method 500, the measured parameter is indicative of vapor phase fluid flow and liquid phase fluid flow.

According to some embodiments of the method 500, the heat pipe comprises an alkali metal fluid. According to some embodiments of the method 500, the alkali metal has a temperature greater than 600° C., a temperature greater than 800° C., a temperature in a range of 600° C. to 900° C., and/or a temperature in a range of 800° C. to 900° C.

The systems and methods disclosed herein are capable of measuring measure flow within an alkali metal heat pipe at temperatures greater than 800° C. The measurement of flow within a heat pipe is a significant technical challenge and differs from traditional pipe flow measurements for various reasons. For example, traditional flow in a pipe is defined as a type of fluid flow within a closed conduit, such as a pipe, duct, or tube. Heat pipe flow is more nuanced, for example, because the flow circuit can be driven by capillary action, the flow circuit can be in a closed system separated by a porous material, the flow circuit comprises two distinct phases, and/or because the countercurrent flows have velocities at different orders of magnitude. The nature of having two phases of flow in a concurrent geometry at two differing velocities can make the measurement of the flow technically challenging. Additionally, the flow circuit of a heat pipe can be delicate closed system, and probing the flow from contact with the working fluid internal to the heat pipe could disrupt the flow dynamics. Various systems and methods disclosed herein can address these technical challenges by measuring heat pipe flow in a non-contact manner. Various systems and methods disclosed herein may be capable of modulating drive coil current frequency of to change the penetration depth of the sensing signal into the flow, for example, to target measurements associated with the vapor phase, liquid phase, or both the vapor phase and liquid phase.

### EXAMPLES

The following examples correspond to experimental testing performed by the inventors using an embodiment of the measurement system 300. As noted above, complex muti-physics and multi-directional flow occurs within the heat pipe 100. The inventors obtained unexpected results showing that that the power of the heat pipe 100 may be correlated with an output voltage differential measured using the eddy current flow sensor 310.

To perform the testing, the evaporator section 102 end of the heat pipe 100 was thermally coupled to a furnace. An insulation sleeve was placed over the condenser section 106 end of the heat pipe 100.

The drive coil 312 of the eddy current flow sensor 310 was energized with AC current modulated to a frequency of 400 Hz. Peak-to-peak voltage differential of the signals received from the first receive coil 314 and the second receive coil 316 was measured as the heat pipe power was adjusted. Temperature of the adiabatic section 104 of the heat pipe 100 was measured using a thermocouple.

Throughout the testing, the heat pipe power was periodically adjusted by modulating the furnace power and by adjusting the position of the insulation sleeve to reveal more or less surface area of the heat pipe 100, thereby adjusting the rate of radiative heat transfer from the condenser section 106.

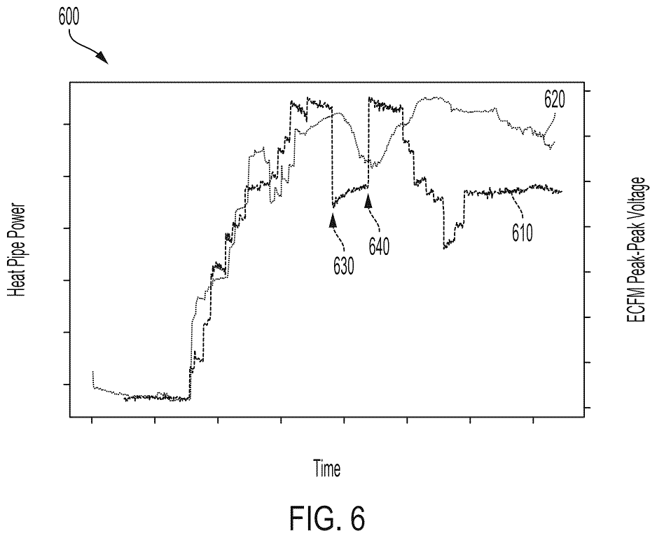

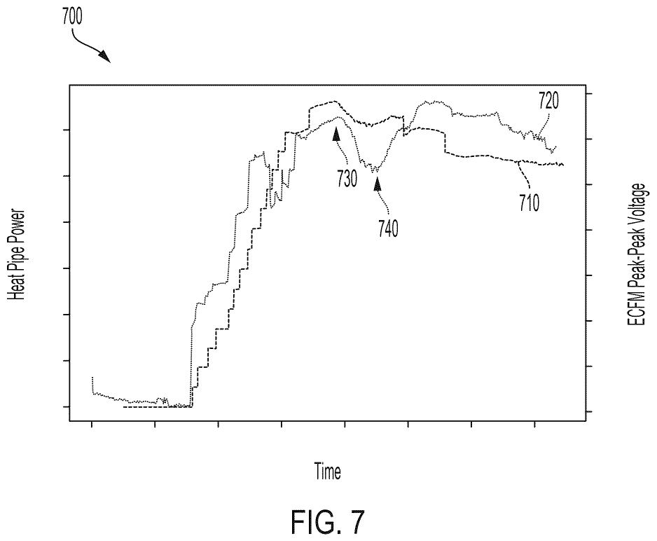

Heat pipe power as a function of time was calculated using two different methods and plotted along peak-to-peak voltage as a function of time, as described below with respect to FIGS. 6 and 7. Furnace power and heat loss from the furnace due to inefficiencies, without use of the heat pipe, was known. Thus, heat pipe power was calculated based on subtracting furnace heat loss from the furnace power.

FIG. 6 is a graph 600 including a first plot 610 of heat pipe power as a function of time, calculated theoretically using heat tracing, and a second plot 620 of measured peak-to-peak voltage as a function of time. The graph 600 shows a strong correlation between heat pipe power and measured peak-to-peak voltage.

FIG. 7 is a graph 700 including a first plot 710 of heat pipe power as a function of time, calculated based on theoretical radiative and natural convective heat transfer, and a second plot 720 of measured peak-to-peak voltage as a function of time. The plots 620 and 720 correspond to the same data. The graph 700 also shows a strong correlation between heat pipe power and measured peak-to-peak voltage.

Point 630 on graph 600 and point 730 on graph 700 correspond to removal of power from the furnace. This was done to confirm that the furnace was not imposing any electromagnetic effects on the voltage measurements. During a period of time following point 630 and 730, the insulation sleeve was not moved, and voltage was monitored. Point 640 on graph 600 and point 740 on graph 700 correspond to return of power from the furnace.

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

Those of ordinary skill in the art will understand that references to the terms “radial” and “concentric” appearing in the Specification and the claims are not necessarily limited to and/or related to circular cross-sections or any particular shapes having an arc and may be used with any shape or geometry having a center of rotation. For example, a square circumscribed in a circle are concentric and a line segment extending from the center of a square towards a side or a corner of the square can be described as a line segment extending radial outward.

Various features and characteristics are described in this specification to provide an understanding of the composition, structure, production, function, and/or operation of the disclosure, which includes the disclosed methods and systems. It is understood that the various features and characteristics of the disclosure described in this specification can be combined in any suitable manner, regardless of whether such features and characteristics are expressly described in combination in this specification. The Inventors and the Applicant expressly intend such combinations of features and characteristics to be included within the scope of the disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the disclosure as defined in the appended claims.

What is claimed is:

1. A method for operating a nuclear reactor, comprising:
measuring a first operating parameter associated with a flow of a working fluid within a heat pipe of the nuclear reactor; and
determining, based on the first operating parameter, a second operating parameter associated with an amount of thermal energy transferred by the heat pipe.

2. The method of claim 1, wherein the first operating parameter is associated with a flow of the working fluid within an adiabatic section of the heat pipe.

3. The method of claim 1, wherein the working fluid comprises an alkali metal.

4. The method of claim 3, wherein the working fluid comprises sodium.

5. The method of claim 2, wherein the first operating parameter is associated with a mass flow rate of the working fluid within the adiabatic section of the heat pipe.

6. The method of claim 5, wherein the mass flow rate of the working fluid is based on flow of a first phase of the working fluid and flow of a second phase of the working fluid.

7. The method of claim 5, wherein the mass flow rate is based on a first portion of the working fluid flowing in a first direction and a second portion of the working fluid flowing in a second direction different from the first direction.

8. The method of claim 2, wherein the first operating parameter corresponds to an electrical signal produced in response to energizing a portion of the flow of the working fluid within the adiabatic section of the heat pipe.

9. The method of claim 8, comprising measuring the first operating parameter with an eddy current flow sensor.

10. The method of claim 1, wherein the second operating parameter is a power of the heat pipe.

11. The method of claim 10, wherein the first operating parameter is associated with a flow rate of the working fluid through the heat pipe, the method further comprising correlating the flow rate of the working fluid to the amount of thermal energy transferred by the heat pipe.

12. The method of claim 1, further comprising controlling an operation of the nuclear reactor based on at least one of the first operating parameter or the second operating parameter.

13. The method of claim 12, comprising maintaining a power level of the nuclear reactor based on detecting a change in the second operating parameter for the heat pipe.

14. The method of claim 13, comprising controlling the operation of the nuclear reactor in real time with detecting the change in the second operating parameter of the heat pipe.

15. A method for transferring heat with a heat pipe system, comprising:
determining a rate of thermal energy transfer within a heat pipe based on a measured parameter indicative of fluid flow within a portion of the heat pipe;
exchanging a portion of the thermal energy as heat between a transfer section of the heat pipe and an environment surrounding the transfer section; and
determining the exchanged portion of the thermal energy based on the rate of thermal energy transfer.

16. The method of claim 15, wherein the portion of the heat pipe is within a condenser section of the heat pipe, an adiabatic section of the heat pipe, or an evaporator section of the heat pipe, or a combination thereof, the method further comprising measuring the measured parameter indicative of fluid flow within the portion of the heat pipe using an eddy current flow sensor.

17. The method of claim 15, further comprising measuring the measured parameter indicative of fluid flow within the portion of the heat pipe with contactless sensor.

18. A measurement system, comprising:
an eddy current sensor configured to be positioned around a portion of a heat pipe; and
a control circuit configured to energize the eddy current sensor at a measurement frequency to determine a flow rate of a working fluid within the portion the heat pipe.

19. The measurement system of claim 18, wherein the working fluid comprises an alkali metal and has an operating temperature in a range of 600 °C. to 900°.

20. The measurement system of claim 18, wherein the portion of the heat pipe is within a condenser section of the heat pipe, an adiabatic section of the heat pipe, or an evaporator section of the heat pipe, or a combination thereof, and wherein the control circuit is configured to calculate a power of the heat pipe based on determining the flow rate of the working fluid within the portion of the heat pipe.
